(19) United States
(12) Patent Application Publication
(10) Pub. No.: US 2024/0256085 A1
(43) Pub. Date: Aug. 1, 2024

(54) ELECTRONIC DEVICE

(71) Applicants: Samsung Display Co., Ltd., Yongin-Si (KR); The Industry & Academic Cooperation in Chungnam National University (IAC), Daejeon (KR)

(72) Inventors: SANGHYUN HEO, Yongin-si (KR); Juneun PARK, Daejeon (KR); KEUMDONG JUNG, Yongin-si (KR)

(21) Appl. No.: 18/377,326

(22) Filed: Oct. 6, 2023

(30) Foreign Application Priority Data
Jan. 30, 2023 (KR) 10-2023-0011503

(51) Int. Cl. G06F 3/041; G06F 3/044

(52) U.S. Cl. CPC G06F 3/04182; G06F 3/04184; G06F 3/0446

(57) ABSTRACT

An electronic device including: a display layer; a sensor layer disposed on the display layer and including first and second electrodes; and a sensor driver to drive the sensor layer and including a signal generation circuit to transmit a transfer signal to the first electrodes, an input detection circuit to receive a sensing signal from the second electrodes, and a sensor control circuit, wherein the input detection circuit is configured to: receive first, second and third sensing signals, and wherein the sensor control circuit includes: a non-ideal element estimator to output a noise signal based on the second sensing signal and the third sensing signal; a calculator to output an output signal by adding or subtracting the first sensing signal and the noise signal; and a converter to output a coordinate signal by converting the output signal into a digital signal.

### CROSS-REFERENCE TO RELATED APPLICATION

This application claims priority under 35 U.S.C. § 119 to Korean Patent Application No. 10-2023-0011503 filed on Jan. 30, 2023, in the Korean Intellectual Property Office, the disclosure of which is incorporated by reference herein in its entirety.

### TECHNICAL FIELD

Embodiments of the present disclosure described herein relate to an electronic device with improved sensing reliability.

### DISCUSSION OF RELATED ART

Multimedia electronic devices, including televisions, mobile phones, tablet personal computers (PCs), navigation systems, game consoles, and others, all include an electronic device that display images Beyond conventional input methods such as buttons, keyboards, and mice, these electronics device may also include a sensor layer. This layer enables a touch-based input method, providing users with an easy and intuitive way to enter information or commands.

### SUMMARY

Embodiments of the present disclosure provide an electronic device with improved sensing reliability.

According to an embodiment of the present disclosure, there is provided an electronic device including: a display layer; a sensor layer disposed on the display layer and including a plurality of first electrodes and a plurality of second electrodes crossing the plurality of first electrodes; and a sensor driver configured to drive the sensor layer and including a signal generation circuit configured to transmit a transfer signal to the plurality of first electrodes, an input detection circuit configured to receive a sensing signal from the plurality of second electrodes, and a sensor control circuit, wherein the input detection circuit is configured to: receive a first sensing signal from one electrode among the plurality of second electrodes, a second sensing signal from a first reference electrode among the plurality of second electrodes, and a third sensing signal from a second reference electrode among the plurality of second electrodes, wherein the one electrode, the first reference electrode and the second electrode are different from each other, and wherein the sensor control circuit includes: a non-ideal element estimator configured to output a noise signal based on the second sensing signal and the third sensing signal; a calculator configured to output an output signal by adding or subtracting the first sensing signal and the noise signal; and a converter configured to output a coordinate signal by converting the output signal into a digital signal.

Each of the first sensing signal, the second sensing signal, the third sensing signal, the noise signal, and the output signal is a charge-domain signal that is an analog signal, and the coordinate signal is a voltage-domain signal that is a digital signal.

The calculator includes a charge pump.

The non-ideal element estimator simultaneously receives the second sensing signal and the third sensing signal.

The sensor control circuit further includes a cache memory, and the cache memory stores the noise signal.

The non-ideal element estimator is connected to the calculator, and the calculator is connected to the input detection circuit, the non-ideal element estimator, and the converter.

The sensor control circuit further includes a repeater connected between the calculator and the converter.

The repeater includes an operational amplifier and a capacitor, which are connected in series with each other.

The sensor control circuit further includes a charge amplifier connected between the calculator and the converter.

The charge amplifier has a single-ended structure.

The charge amplifier has an open loop structure.

The electronic device may further include: a display driver configured to drive the display layer, wherein the display driver generates a vertical synchronization signal and a horizontal synchronization signal, wherein the sensor control circuit receives the vertical synchronization signal and the horizontal synchronization signal, and wherein the non-ideal element estimator outputs the noise signal by further using the vertical synchronization signal and the horizontal synchronization signal.

The non-ideal element estimator calculates the noise signal by adding or subtracting values obtained by multiplying the second sensing signal by a predetermined first ratio and the third sensing signal by a predetermined second ratio.

When the sensor driver detects the second sensing signal and the third sensing signal, the signal generation circuit provides a voltage to the plurality of first electrodes.

According to an embodiment of the present disclosure, there is provided an electronic device including: a display layer; a sensor layer disposed on the display layer and including a plurality of sensing electrodes; and a sensor driver including: a signal generation circuit configured to drive the sensor layer and to transmit a first transfer signal to a first electrode among the plurality of sensing electrodes; an input detection circuit configured to receive a first sensing signal from a second electrode among the plurality of sensing electrodes, and first and second reference signals from at least two sensing electrodes other than the first electrode and the second electrode among the plurality of sensing electrodes; and a sensor control circuit, and wherein the sensor control circuit includes: a non-ideal element estimator configured to output a noise signal based on the first and second reference signals; a calculator configured to output an output signal by adding or subtracting the first sensing signal and the noise signal; and a converter configured to output a coordinate signal by converting the output signal into a digital signal.

The calculator includes a charge pump.

The sensor control circuit further includes a cache memory, and the cache memory stores the noise signal.

The non-ideal element estimator is connected to the calculator, and the calculator is connected to the input detection circuit, the non-ideal element estimator, and the converter.

The sensor control circuit further includes an amplifier connected between the calculator and the converter.

The electronic device may further include: a display driver configured to drive the display layer, wherein the display driver generates a vertical synchronization signal and a horizontal synchronization signal, wherein the sensor control circuit receives the vertical synchronization signal and the horizontal synchronization signal, and wherein the non-ideal element estimator outputs the noise signal by further using the vertical synchronization signal and the horizontal synchronization signal.

### BRIEF DESCRIPTION OF THE DRAWINGS

The above and other features of the present disclosure will become apparent by describing in detail embodiments thereof with reference to the accompanying drawings.

FIG. 1 is a perspective view of an electronic device, according to an embodiment of the present disclosure.

FIG. 2 is a block diagram illustrating an operation of an electronic device, according to an embodiment of the present disclosure.

FIG. 3A is a cross-sectional view of an electronic device, according to an embodiment of the present disclosure.

FIG. 3B is a cross-sectional view of an electronic device, according to an embodiment of the present disclosure.

FIG. 4 is a cross-sectional view of an electronic device, according to an embodiment of the present disclosure.

FIG. 5 is a block diagram of a display layer and a display driver, according to an embodiment of the present disclosure.

FIG. 6 is a block diagram of a sensor layer and a sensor driver, according to an embodiment of the present disclosure.

FIG. 7 is a flowchart illustrating a method of driving an electronic device, according to an embodiment of the present disclosure.

FIG. 8 is a circuit diagram illustrating a sensor layer and a sensor driver, according to an embodiment of the present disclosure.

FIG. 9 is a graph showing sensing signals and reference signals, according to an embodiment of the present disclosure.

FIG. 10 is a circuit diagram illustrating a sensor layer and a sensor driver, according to an embodiment of the present disclosure.

FIG. 11 is a circuit diagram illustrating a sensor layer and a sensor driver, according to an embodiment of the present disclosure.

FIG. 12 is a circuit diagram illustrating a sensor layer and a sensor driver, according to an embodiment of the present disclosure.

### DETAILED DESCRIPTION OF THE EMBODIMENTS

In this specification, the expression that a first component (or region, layer, part, portion, etc.) is “on”, “connected with”, or “coupled with” a second component may mean that the first component is directly on, connected with, or coupled with the second component or may mean that a third component is interposed therebetween.

The same reference numerals may refer to the same components. Additionally, in drawings, the thickness, ratio, and dimension of components may be exaggerated for a more effective description of the technical contents set forth herein. The term “and/or” includes one or more combinations in each of which associated elements are defined.

Although the terms “first”, “second”, etc. may be used to describe various components, the components should not be construed as being limited by the terms. The terms are used to distinguish one component from another component. For example, a first component may be referred to as a second component, and similarly, the second component may be referred to as the first component. The articles “a,” “an,” and “the” are singular in that they have a single referent, but the use of the singular form in this specification should not preclude the presence of more than one referent.

Additionally, the terms “under”, “below”, “on”, “above”, etc. are used to describe the correlation of components illustrated in drawings. The terms that are relative in concept are described based on a direction shown in drawings.

It will be understood that the terms “include”, “comprise”, “have”, etc. specify the presence of features, numbers, steps, operations, elements, or components, described in the specification, or a combination thereof, and do not preclude the presence or additional possibility of one or more other features, numbers, steps, operations, elements, or components or a combination thereof.

Unless otherwise defined, all terms (including technical terms and scientific terms) used in this specification have the same meaning as commonly understood by one skilled in the art to which the present disclosure belongs. Furthermore, terms such as terms defined in the dictionaries commonly used should be interpreted as having a meaning consistent with their meaning in the context of the related technology, and should not be interpreted in an ideal or overly formal sense unless explicitly defined herein.

Hereinafter, embodiments of the present disclosure will be described with reference to the accompanying drawings.

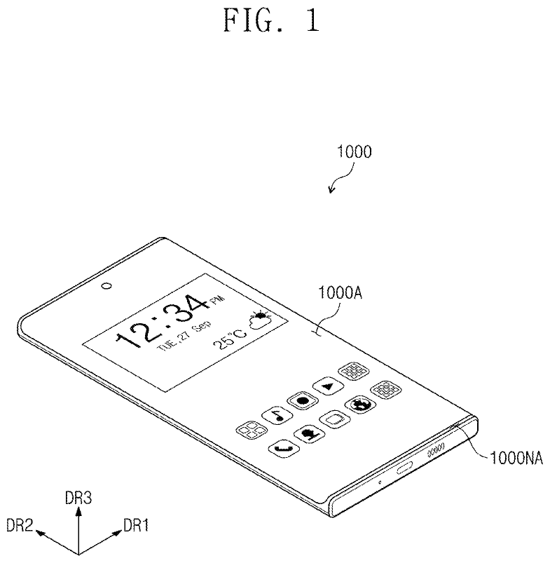

FIG. 1 is a perspective view of an electronic device, according to an embodiment of the present disclosure.

Referring to FIG. 1, an electronic device 1000 may be a device activated depending on an electrical signal. In other words, the electronic device 1000 operates based on electrical signals. For example, the electronic device 1000 may be a mobile phone, a foldable mobile phone, a notebook computer, a television, a tablet personal computer (PC), a car navigation system, a game console, or a wearable device, but is not limited thereto. FIG. 1 illustrates that the electronic device 1000 is a mobile phone.

An active area 1000A and a peripheral area 1000NA may be provided in the electronic device 1000. The electronic device 1000 may display an image through the active area 1000A. The active area 1000A may include a surface formed by a first direction DR1 and a second direction DR2. The peripheral area 1000NA may surround the periphery of the active area 1000A. In some cases, the peripheral area 1000NA may be disposed on fewer than all sides of the active area 1000A.

A thickness direction of the electronic device 1000 may be parallel to a third direction DR3 intersecting the first direction DR1 and the second direction DR2. Accordingly, front surfaces (or upper surfaces) and back surfaces (or lower surfaces) of members constituting the electronic device 1000 may be described with respect to the third direction DR3.

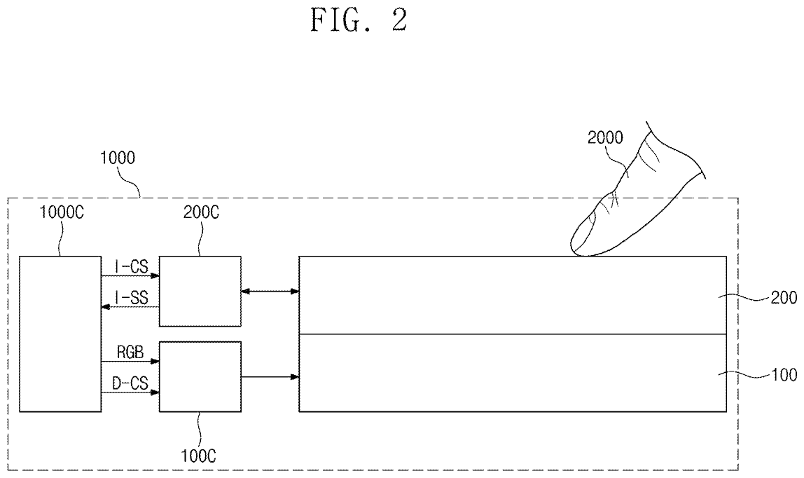

FIG. 2 is a block diagram illustrating an operation of an electronic device, according to an embodiment of the present disclosure.

Referring to FIG. 2, the electronic device 1000 may include a display layer 100, the sensor layer 200, a display driver 100C, a sensor driver 200C, and a main driver 1000C.

The display layer 100 may be a component that substantially generates an image. The display layer 100 may be a light emitting display layer. For example, the display layer 100 may be an organic light emitting display layer, a quantum dot display layer, a micro-light emitting diode (LED) display layer, or a nano-LED display layer. The display layer 100 may be referred to as a “display panel”.

The sensor layer 200 may be disposed on the display layer 100. The sensor layer 200 may be located closer to the external surface of the electronic device 100 than the display layer 100. The sensor layer 200 may sense an external input 2000 applied from the outside. The external input 2000 may include any input means capable of providing a change in capacitance. In other words, the external input 2000 could encompass any input means capable of inducing a change in capacitance. For example, the sensor layer 200 may sense not only a passive-type input means such as a user's body, but also an input by an active-type input means that provides a transfer signal. The sensor layer 200 may be referred to as a “sensor”, “touch layer”, “touch panel”, “input sensing layer”, or “input sensing panel”.

The main driver 1000C may control overall operations of the electronic device 1000. For example, the main driver 1000C may control operations of the display driver 100C and the sensor driver 200C. The main controller 1000C may include at least one microprocessor, and the main controller 1000C may be referred to as a “host”. The main driver 1000C may further include a graphic controller.

The display driver 100C may drive the display layer 100. The display driver 100C may receive image data RGB and a control signal D-CS from the main driver 1000C. The control signal D-CS may include various signals. For example, the control signal D-CS may include an input vertical synchronization signal, an input horizontal synchronization signal, a main clock, and a data enable signal. The display driver 100C may generate a scan control signal and a data control signal that control the driving of the display layer 100 based on the control signal D-CS.

The sensor driver 200C may drive the sensor layer 200. The sensor driver 200C may receive a control signal I-CS from the main driver 1000C. The control signal I-CS may include a clock signal of the sensor layer 200.

The sensor driver 200C may calculate coordinate information of an input based on a signal received from the sensor layer 200 and may provide the main driver 1000C with a coordinate signal I-SS having the coordinate information. The main driver 1000C executes an operation corresponding to a user input based on the coordinate signal I-SS. For example, the main driver 1000C may operate the display driver 100C to display a new application image on the display layer 100.

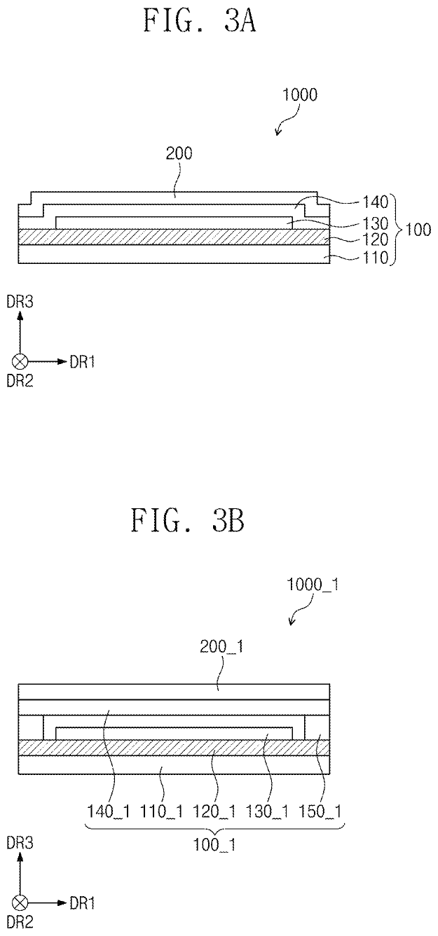

FIG. 3A is a cross-sectional view of an electronic device, according to an embodiment of the present disclosure.

Referring to FIG. 3A, the display layer 100 may include a base layer 110, a circuit layer 120, a light emitting element layer 130, and an encapsulation layer 140.

The base layer 110 may be a member that provides a base surface on which the circuit layer 120 is disposed. The base layer 110 may be a glass substrate, a metal substrate, a polymer substrate, or the like. However, an embodiment is not limited thereto, and the base layer 110 may be an inorganic layer, an organic layer, or a composite material layer.

The base layer 110 may have a multi-layer structure. For example, the base layer 110 may include a first synthetic resin layer, a silicon oxide (SiOx) layer disposed on the first synthetic resin layer, an amorphous silicon (a-Si) layer disposed on the silicon oxide layer, and a second synthetic resin layer disposed on the amorphous silicon layer. The silicon oxide layer and the amorphous silicon layer may be referred to as a “base barrier layer”.

Each of the first and second synthetic resin layers may include polyimide-based resin. Additionally, each of the first and second synthetic resin layers may include at least one of acrylate-based resin, methacrylate-based resin, polyisoprene-based resin, vinyl-based resin, epoxy-based resin, urethane-based resin, cellulose-based resin, siloxane-based resin, polyamide-based resin, and perylene-based resin. In this specification, “˜˜”-based resin may mean including the functional group of “˜˜”.

The circuit layer 120 may be disposed on the base layer 110. The circuit layer 120 may include an insulating layer, a semiconductor pattern, a conductive pattern, and a signal wire. The insulating layer, the semiconductor layer, and the conductive layer may be formed on the base layer 110 using a technique such as coating, evaporation, or the like. Afterward, the insulating layer, the semiconductor layer, and the conductive layer may be selectively patterned by performing a photolithography process multiple times. Afterward, the semiconductor pattern, the conductive pattern, and the signal wire included in the circuit layer 120 may be formed.

The light emitting element layer 130 may be disposed on the circuit layer 120. The light emitting element layer 130 may include a light emitting element. For example, the light emitting element layer 130 may include an organic light emitting material, a quantum dot, a quantum rod, a micro-LED, or a nano-LED.

The encapsulation layer 140 may be disposed on the light emitting element layer 130. The encapsulation layer 140 may protect the light emitting element layer 130 from foreign substances such as moisture, oxygen, and dust particles. The encapsulation layer 140 may be further disposed on the circuit layer 120.

The sensor layer 200 may be disposed on the display layer 100. For example, the sensor layer 200 may be disposed on the encapsulation layer 140. The sensor layer 200 may sense an external input applied from the outside. The external input may be a user input. The user input may include various types of external inputs such as a part of a user's body, light, heat, a pen, or pressure.

The sensor layer 200 may be formed on the display layer 100 through a successive process. In this case, the sensor layer 200 may be expressed as being directly disposed on the display layer 100. “Being directly disposed” may mean that a third component is not interposed between the sensor layer 200 and the display layer 100. In other words, a separate adhesive member may not be interposed between the sensor layer 200 and the display layer 100. Alternatively, the sensor layer 200 may be coupled to the display layer 100 through an adhesive member. The adhesive member may include a common adhesive or a common sticking agent.

The electronic device 1000 may further include an anti-reflection layer and an optical layer, which are disposed on the sensor layer 200. The anti-reflection layer may reduce the reflectance of external light incident from the outside of the electronic device 1000. The optical layer may improve the front luminance of the electronic device 1000 by controlling a direction of light incident from the display layer 100.

FIG. 3B is a cross-sectional view of an electronic device, according to an embodiment of the present disclosure.

Referring to FIG. 3B, an electronic device 1000_1 may include a display layer 100_1 and a sensor layer 200_1. The display layer 100_1 may include a base substrate 110_1, a circuit layer 120_1, a light emitting element layer 130_1, an encapsulation substrate 140_1, and a coupling member 150_1.

Each of the base substrate 110_1 and the encapsulation substrate 140_1 may be a glass substrate, a metal substrate, or a polymer substrate, but is not particularly limited thereto.

The coupling member 150_1 may be interposed between the base substrate 110_1 and the encapsulation substrate 140_1. The coupling member 150_1 may couple the encapsulation substrate 140_1 to the base substrate 110_1 or the circuit layer 120_1. The coupling member 150_1 may include an inorganic material or an organic material. For example, the inorganic material may include a frit seal, and the organic material may include a photo-curable resin or a photo-plastic resin. However, the material constituting the coupling member 150_1 is not limited to the example.

The sensor layer 200_1 may be directly disposed on the encapsulation substrate 140_1. “Being directly disposed” may mean that a third component is not interposed between the sensor layer 200_1 and the encapsulation substrate 140_1. In other words, a separate adhesive member may not be interposed between the sensor layer 200_1 and the display layer 100_1. However, an embodiment is not limited thereto, and an adhesive layer may be further interposed between the sensor layer 200_1 and the encapsulation substrate 140_1.

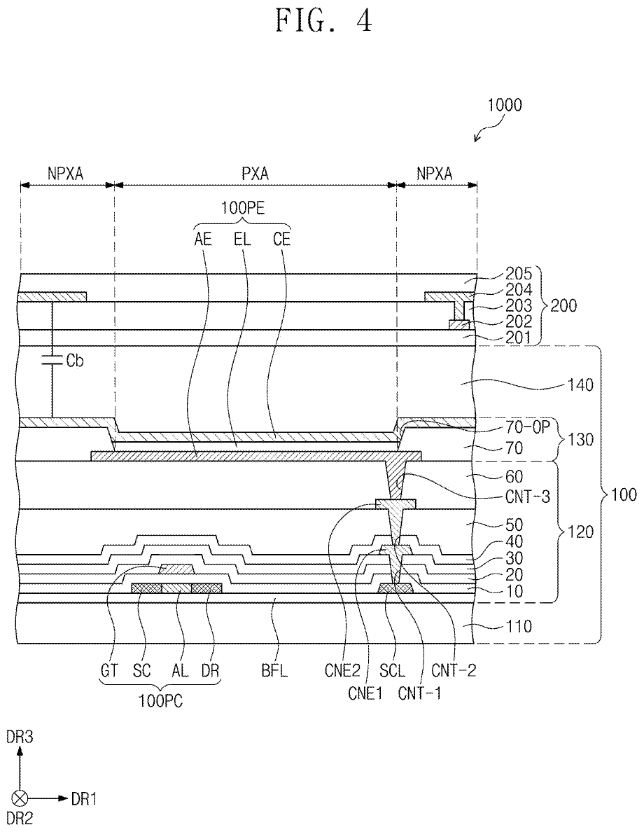

FIG. 4 is a cross-sectional view of an electronic device, according to an embodiment of the present disclosure.

Referring to FIG. 4, at least one inorganic layer is formed on the upper surface of the base layer 110. The inorganic layer may include at least one of aluminum oxide, titanium oxide, silicon oxide, silicon nitride, silicon oxynitride, zirconium oxide, and hafnium oxide. The inorganic layer may be formed of multiple layers. The multiple inorganic layers may constitute a barrier layer and/or a buffer layer. In an embodiment, the display layer 100 is illustrated as including a buffer layer BFL.

The buffer layer BFL may improve a bonding force between the base layer 110 and a semiconductor pattern. The buffer layer BFL may include at least one of silicon oxide, silicon nitride, and silicon oxynitride. For example, the buffer layer BFL may include a structure in which a silicon oxide layer and a silicon nitride layer are stacked alternately.

The semiconductor pattern may be disposed on the buffer layer BFL. The semiconductor pattern may include polysilicon. However, an embodiment is not limited thereto, and the semiconductor pattern may include amorphous silicon, low-temperature polycrystalline silicon, or an oxide semiconductor.

FIG. 4 only illustrates a part of the semiconductor pattern, and the semiconductor pattern may be further disposed in another area. The semiconductor pattern may be arranged in a specific rule throughout pixels. In other words, the semiconductor pattern may be arranged across the pixels following a specific rule. The semiconductor pattern may have electrical characteristics different depending on whether the semiconductor pattern is doped. The semiconductor pattern may include a first area having high conductivity and a second area having low conductivity. The first area may be doped with an N-type dopant or a P-type dopant. A P-type transistor may include an area doped with the P-type dopant, and an N-type transistor may include an area doped with the N-type dopant. The second area may be an undoped area or an area doped with a concentration lower than a concentration in the first area.

The conductivity of the first area is greater than the conductivity of the second area. The first area may function as an electrode or a signal wire. The second area may correspond to an active (or a channel) of a transistor. In other words, a part of the semiconductor pattern may be an active of the transistor. Another part of the semiconductor pattern may be a source or drain of the transistor. And yet another part of the semiconductor pattern may be a connection electrode or a connection signal wire.

Each of pixels may be expressed by an equivalent circuit including seven transistors, one capacitor, and a light emitting element 100PE, and the equivalent circuit of the pixel may be modified in various forms. One transistor 100PC and the one light emitting element 100PE included in a pixel are illustrated in FIG. 4 by way of example.

A source SC, an active AL, and a drain DR of the transistor 100PC may be formed by using a semiconductor pattern. The source SC and the drain DR may extend in directions opposite to each other from the active AL on a cross section. A part of a connection signal wire SCL formed from the semiconductor pattern is illustrated in FIG. 4. The connection signal wire SCL may be connected to the drain DR of the transistor 100PC on a plane.

A first insulating layer 10 may be disposed on the buffer layer BFL. The first insulating layer 10 may overlap a plurality of pixels in common and may cover the semiconductor pattern. The first insulating layer 10 may be an inorganic layer and/or an organic layer, and may have a single layer structure or a multi-layer structure. The first insulating layer 10 may include at least one of aluminum oxide, titanium oxide, silicon oxide, silicon nitride, silicon oxynitride, zirconium oxide, and hafnium oxide. In an embodiment, the first insulating layer 10 may be a single silicon oxide layer. Not only the first insulating layer 10 but also an insulating layer of the circuit layer 120 to be described later may be an inorganic layer and/or an organic layer, and may have a single layer structure or a multi-layer structure. The inorganic layer may include at least one of the above-described materials, but is not limited thereto.

A gate GT of the transistor 100PC is disposed on the first insulating layer 10. The gate GT may be a part of a metal pattern. The gate GT overlaps the active AL. In a process of doping the semiconductor pattern, the gate GT may function as a mask.

A second insulating layer 20 is disposed on the first insulating layer 10 and may cover the gate GT. The second insulating layer 20 may overlap pixels in common. The second insulating layer 20 may be an inorganic layer and/or an organic layer, and may have a single layer structure or a multi-layer structure. The second insulating layer 20 may include at least one of silicon oxide, silicon nitride, and silicon oxynitride. In an embodiment, the second insulating layer 20 may have a multi-layer structure including a silicon oxide layer and a silicon nitride layer.

A third insulating layer 30 may be disposed on the second insulating layer 20. The third insulating layer 30 may have a single layer structure or a multi-layer structure. For example, the third insulating layer 30 may have a multi-layer structure including a silicon oxide layer and a silicon nitride layer.

A first connection electrode CNE1 may be disposed on the third insulating layer 30. The first connection electrode CNE1 may be connected to the connection signal wire SCL through a contact hole CNT-1 penetrating the first, second, and third insulating layers 10, 20, and 30. The first connection electrode CNE1 may be electrically connected to the connection signal wire SCL via the contact hole CNT-1.

A fourth insulating layer 40 may be disposed on the third insulating layer 30. The fourth insulating layer 40 may be a single silicon oxide layer. A fifth insulating layer 50 may be disposed on the fourth insulating layer 40. The fifth insulating layer 50 may be an organic layer.

A second connection electrode CNE2 may be disposed on the fifth insulating layer 50. The second connection electrode CNE2 may be connected to the first connection electrode CNE1 through a contact hole CNT-2 passing through the fourth insulating layer 40 and the fifth insulating layer 50.

A sixth insulating layer 60 may be disposed on the fifth insulating layer 50 and may cover the second connection electrode CNE2. The sixth insulating layer 60 may be an organic layer.

The light emitting element layer 130 may be disposed on the circuit layer 120. The light emitting element layer 130 may include the light emitting element 100PE. For example, the light emitting element layer 130 may include an organic light emitting material, a quantum dot, a quantum rod, a micro-LED, or a nano-LED. Hereinafter, the description will be given under the condition that the light emitting element 100PE is an organic light emitting element, but an embodiment is not particularly limited thereto.

The light emitting element 100PE may include a first electrode AE, a light emitting layer EL, and a second electrode CE.

The first electrode AE may be disposed on the sixth insulating layer 60. The first electrode AE may be connected to the second connection electrode CNE2 through a contact hole CNT-3 penetrating the sixth insulating layer 60. In other words, the first electrode AE may be electrically connected to the connection signal wire SCL via the first, second and third connection electrodes CNE1 to CNE3.

A pixel defining layer 70 may be disposed on the sixth insulating layer 60 and may cover a portion of the first electrode AE. An opening 70-OP is defined in the pixel defining layer 70. The opening 70-OP of the pixel defining layer 70 exposes at least part of the first electrode AE.

The active area 1000A (see FIG. 1) may include an emission area PXA and a non-emission area NPXA adjacent to the emission area PXA. The non-emission area NPXA may surround the emission area PXA. In an embodiment, the emission area PXA corresponds to a partial area of the first electrode AE, which is exposed by the opening 70-OP. In other words, the emission area PXA overlaps the portion of the first electrode AE exposed by the opening 70-OP.

The light emitting layer EL may be disposed on the first electrode AE. The light emitting layer EL may be disposed in an area corresponding to the opening 70-OP. In other words, the light emitting layer EL may be separately formed on each of pixels. When the light emitting layers EL are separately formed in each of pixels, each of the light emitting layers EL may emit light of at least one of a blue color, a red color, and a green color. However, an embodiment is not limited thereto. For example, the light emitting layer EL may be connected and provided to each of the pixels in common. In this case, the light emitting layer EL may provide blue light or white light.

The second electrode CE may be disposed on the light emitting layer EL. The second electrode CE may be integrally disposed in a plurality of pixels in common.

A hole control layer may be interposed between the first electrode AE and the light emitting layer EL. The hole control layer may be disposed in common in the emission area PXA and the non-emission area NPXA. The hole control layer may include a hole transport layer and may further include a hole injection layer. An electron control layer may be interposed between the light emitting layer EL and the second electrode CE. The electron control layer may include an electron transport layer, and may further include an electron injection layer. The hole control layer and the electron control layer may be formed in common in a plurality of pixels by using an open mask.

The encapsulation layer 140 may be disposed on the light emitting element layer 130. The encapsulation layer 140 may include an inorganic layer, an organic layer, and an inorganic layer sequentially stacked, and layers constituting the encapsulation layer 140 are not limited thereto.

The inorganic layers may protect the light emitting element layer 130 from moisture and oxygen, and the organic layer may protect the light emitting element layer 130 from a foreign material such as dust particles. The inorganic layers may include a silicon nitride layer, a silicon oxynitride layer, a silicon oxide layer, a titanium oxide layer, an aluminum oxide layer, or the like. The organic layer may include an acrylate-based organic layer, but is not limited thereto.

The sensor layer 200 may include a base layer 201, a first conductive layer 202, a sensing insulating layer 203, a second conductive layer 204, and a cover insulating layer 205.

The base layer 201 may be an inorganic layer including at least one of silicon nitride, silicon oxynitride, and silicon oxide. Alternatively, the base layer 201 may be an organic layer including an epoxy resin, an acrylate resin, or an imide-based resin. The base layer 201 may have a single-layer structure or may have a multi-layer structure stacked in the third direction DR3.

Each of the first conductive layer 202 and the second conductive layer 204 may have a single layer structure or may have a multi-layer structure stacked in the third direction DR3.

A conductive layer of a single layer structure may include a metal layer or a transparent conductive layer. The metal layer may include molybdenum, silver, titanium, copper, aluminum, or an alloy thereof. The transparent conductive layer may include a transparent conductive oxide such as indium tin oxide (ITO), indium zinc oxide (IZO), zinc oxide (ZnO), indium zinc tin oxide (IZTO), or the like. Additionally, the transparent conductive layer may include a conductive polymer such as PEDOT, a metal nano wire, graphene, and the like.

A conductive layer of the multi-layer structure may include metal layers. For example, the metal layers may have a three-layer structure of titanium/aluminum/titanium. The conductive layer of the multi-layer structure may include at least one metal layer and at least one transparent conductive layer.

At least one of the detection insulating layer 203 and the cover insulating layer 205 may include an inorganic film. The inorganic film may include at least one of aluminum oxide, titanium oxide, silicon oxide, silicon nitride, silicon oxynitride, zirconium oxide, and hafnium oxide.

At least one of the sensing insulating layer 203 and the cover insulating layer 205 may include an organic film. The organic film may include at least one of acrylate-based resin, methacrylate-based resin, polyisoprene, vinyl-based resin, epoxy-based resin, urethane-based resin, cellulose-based resin, siloxane-based resin, polyimide-based resin, polyamide-based resin, and perylene-based resin.

A parasitic capacitor Cb may be formed between the sensor layer 200 and the second electrode CE. The parasitic capacitor Cb may also be referred to as “base capacitance”. As a distance between the sensor layer 200 and the second electrode CE decreases, the capacitance of the parasitic capacitor Cb may increase. As the capacitance of the parasitic capacitor Cb increases, a ratio of an amount of change in capacitance to a reference value may decrease. The amount of change in capacitance may mean a change in capacitance that occurs between before an input by an input means, for example, a body 2000 (see FIG. 2) of a user, and after an input by the input means. In other words, the change in capacitance refers to the shift in capacitance before and after a user, for example, interacts with the sensor layer 200.

The sensor driver 200C (see FIG. 2) that processes a signal detected from the sensor layer 200 may perform a leveling operation in which a value corresponding to the capacitance of the parasitic capacitance Cb is removed from the detected signal. The ratio of the amount of change in capacitance to the reference value is increased by the leveling operation, thereby improving sensing sensitivity.

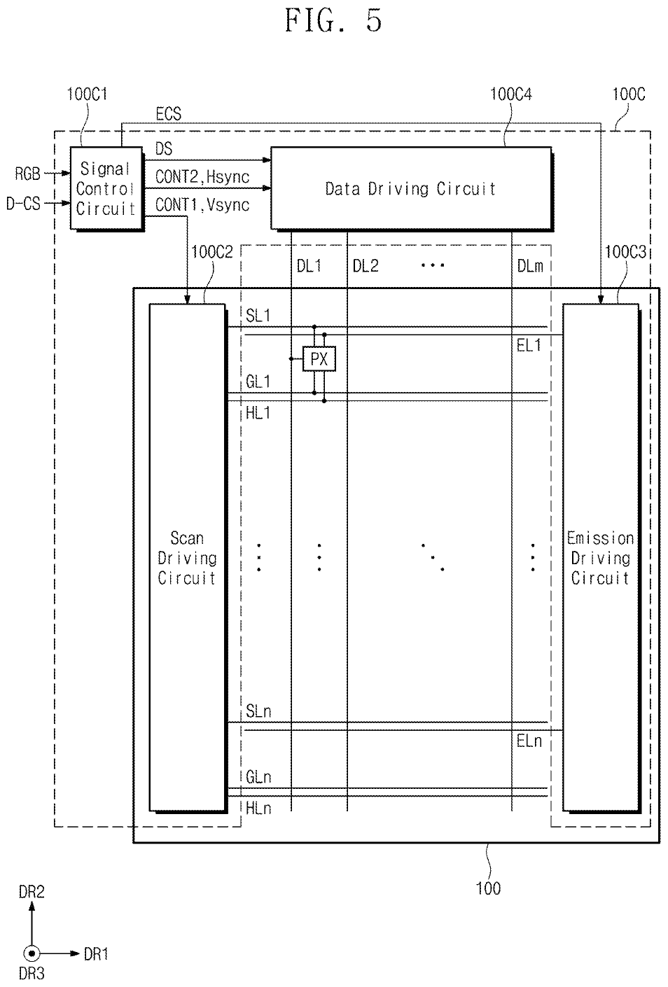

FIG. 5 is a block diagram of a display layer and a display driver, according to an embodiment of the present disclosure.

Referring to FIG. 5, the display layer 100 may include a plurality of first scan wires SL1 to SLn, a plurality of second scan wires GL1 to GLn, a plurality of third scan wires HL1 to HLn, a plurality of emission control wires EL1 to ELn, a plurality of data wires DL1 to DLm, and a plurality of pixels PX. The plurality of first scan wires SL1 to SLn, the plurality of second scan wires GL1 to GLn, the plurality of third scan wires HL1 to HLn, and the plurality of emission control wires EL1 to ELn may extend in the first direction DR1. The plurality of first scan wires SL1 to SLn, the plurality of second scan wires GL1 to GLn, the plurality of third scan wires HL1 to HLn, and the plurality of emission control wires EL1 to ELn may be spaced apart from one another in the second direction DR2. The plurality of data wires DL1 to DLm may extend in the second direction DR2. The plurality of data wires DL1 to DLm may be spaced apart from one another in the first direction DR1.

The display driver 100C may include a signal control circuit 100C1, a scan driving circuit 100C2, an emission driving circuit 100C3, and a data driving circuit 100C4.

The signal control circuit 100C1 may receive the image data RGB and the control signal D-CS from the main driver 1000C (see FIG. 2). The control signal D-CS may include various signals. For example, the control signal D-CS may include an input vertical synchronization signal, an input horizontal synchronization signal, a main clock, and a data enable signal.

The signal control circuit 100C1 may generate a first control signal CONT1 and a vertical synchronization signal Vsync, and may output the first control signal CONT1 and the vertical synchronization signal Vsync to the scan driving circuit 100C2, based on the control signal D-CS. The vertical synchronization signal Vsync may be included in the first control signal CONT1.

The signal control circuit 100C1 may generate a third control signal ECS based on the control signal D-CS and may output the third control signal ECS to the emission driving circuit 100C3.

The signal control circuit 100C1 may generate a second control signal CONT2 and a horizontal synchronization signal Hsync, and may output the second control signal CONT2 and the horizontal synchronization signal Hsync to the data driving circuit 100C4, based on the control signal D-CS. The horizontal synchronization signal Hsync may be included in the second control signal CONT2.

Furthermore, the signal control circuit 100C1 may output, to the data driving circuit 100C4, a driving signal DS obtained by processing the image data RGB under an operating condition of the display layer 100. The first control signal CONT1 and the second control signal CONT2 are signals necessary for operations of the scan driving circuit 100C2 and the data driving circuit 100C4 and are not particularly limited thereto.

The scan driving circuit 100C2 drives the plurality of first scan wires SL1 to SLn, the plurality of second scan wires GL1 to GLn, and the plurality of third scan wires HL1 to HLn in response to the first control signal CONT1 and the vertical synchronization signal Vsync. In an embodiment of the present disclosure, the scan driving circuit 100C2 may be formed in the same process as the circuit layer 120 (see FIG. 4) in the display layer 100, but is not limited thereto. For example, the scan driving circuit 100C2 may be implemented as an integrated circuit (IC). The scan driving circuit 100C2 may be directly mounted in a predetermined area of the display layer 100 or may be mounted on a separate printed circuit board in a chip on film (COF) scheme, and then may be electrically connected to the display layer 100.

The emission driving circuit 100C3 receives the third control signal ECS from the signal control circuit 100C1. The emission driving circuit 100C3 may output emission control signals to the emission control wires EL1 to ELn in response to the third control signal ECS.

The data driving circuit 100C4 may output grayscale voltages to the plurality of data wires DL1 to DLm in response to the second control signal CONT2, the vertical synchronization signal Hsync, and the driving signal DS that are received from the signal control circuit 100C1. The data driving circuit 100C4 may be implemented with an IC. The data driving circuit 100C3 may be directly mounted in a predetermined area of the display layer 100 or may be mounted on a separate printed circuit board in a COF scheme, and then may be electrically connected to the display layer 100, but is not particularly limited thereto. For example, the data driving circuit 100C4 may be formed in the same process as the circuit layer 120 (see FIG. 4) in the display layer 100.

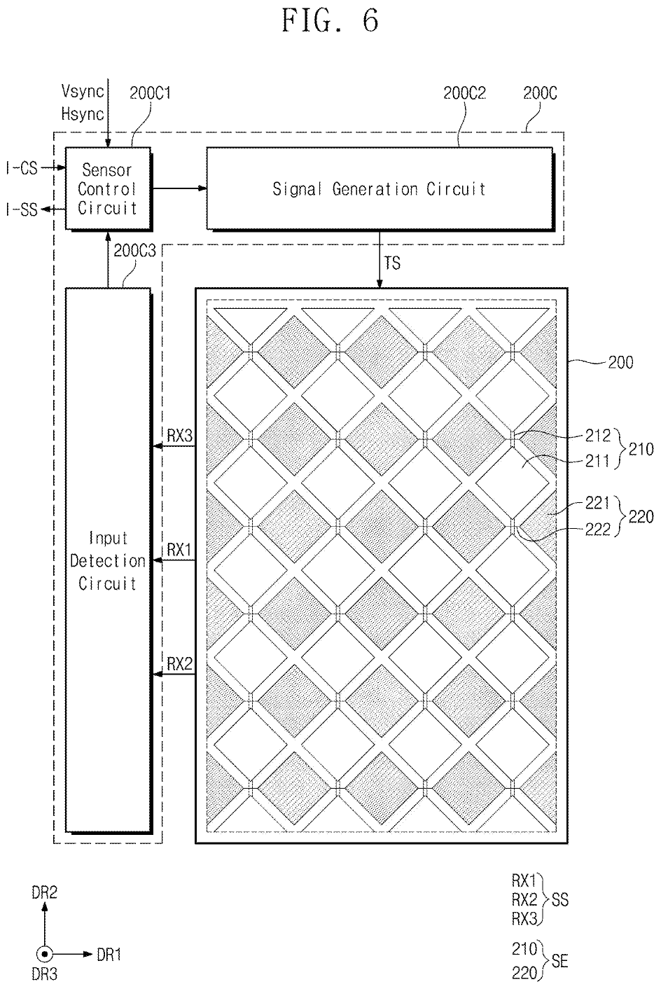

FIG. 6 is a block diagram of a sensor layer and a sensor driver, according to an embodiment of the present disclosure.

Referring to FIG. 6, the sensor layer 200 may include a plurality of sensing electrodes SE. The plurality of sensing electrodes SE may include a plurality of first electrodes 210 and a plurality of second electrodes 220. The plurality of second electrodes 220 may be intersected with the plurality of first electrodes 210. The sensor layer 200 may further include a plurality of signal wires connected to the plurality of first electrodes 210 and the plurality of second electrodes 220.

The plurality of first electrodes 210 may be arranged in the first direction DR1. Each of the plurality of first electrodes 210 may extend in the second direction DR2. Each of the plurality of first electrodes 210 may include a sensing pattern 211 and a bridge pattern 212. The two sensing patterns 211 adjacent to each other may be electrically connected to each other by the two bridge patterns 212, but are not particularly limited thereto. The sensing pattern 211 may be included in the second conductive layer 204 (see FIG. 4), and the bridge pattern 212 may be included in the first conductive layer 202 (see FIG. 4).

The plurality of second electrodes 220 may be arranged in the second direction DR2. Each of the plurality of second electrodes 220 may extend in the first direction DR1. Each of the plurality of second electrodes 220 may include a first portion 221 and a second portion 222. The two bridge patterns 212 may be intersected with the second portion 222 in an insulation scheme. In other words, the two bridge patterns 212 may be insulated from the second portion 222. The first portion 221 and the second portion 222 may have integral shapes with each other and may be disposed on the same layer. For example, the first portion 221 and the second portion 222 may be included in the second conductive layer 204 (see FIG. 4).

The sensor layer 200 may further include at least one dummy electrode adjacent to the plurality of sensing electrodes SE.

The sensor driver 200C may receive the control signal I-CS from the main driver 1000C (see FIG. 2) and may provide the coordinate signal I-SS to the main driver 1000C (see FIG. 2).

The sensor driver 200C may be implemented as an IC. The sensor driver 200C implemented as an IC may be directly mounted in a predetermined area of the sensor layer 200 or may be mounted on a separate printed circuit board in a COF scheme, and then may be electrically connected to the sensor layer 200.

The sensor driver 200C may include a sensor control circuit 200C1, a signal generation circuit 200C2, and an input detection circuit 200C3.

The sensor control circuit 200C1 may receive the vertical synchronization signal Vsync and the vertical synchronization signal Hsync from the display driver 100C. The sensor control circuit 200C1 may control operations of the signal generation circuit 200C2 and the input detection circuit 200C3 based on the control signal I-CS, the vertical synchronization signal Vsync, and the vertical synchronization signal Hsync.

The signal generation circuit 200C2 may output transfer signals TS to the sensor layer 200, for example, the plurality of first electrodes 210. However, this is an example. For example, the signal generation circuit 200C2 according to an embodiment of the present disclosure may transmit the transfer signal TS to the plurality of second electrodes 220. The signal generation circuit 200C2 may sequentially output the transfer signals TS to the first electrodes 210.

The input detection circuit 200C3 may receive the sensing signals SS from the sensor layer 200. For example, the input detection circuit 200C3 may receive the sensing signals SS from the plurality of second electrodes 220. However, this is an example. For example, the input detection circuit 200C3 according to an embodiment of the present disclosure may receive the sensing signals SS from the plurality of first electrodes 210.

The sensing signals SS may include a first sensing signal RX1 and at least two reference signals.

The first sensing signal RX1 may be a signal received from one electrode of the plurality of second electrodes 220. The first sensing signal RX1 may be a signal received from a sensing electrode to be measured by the input detection circuit 200C3.

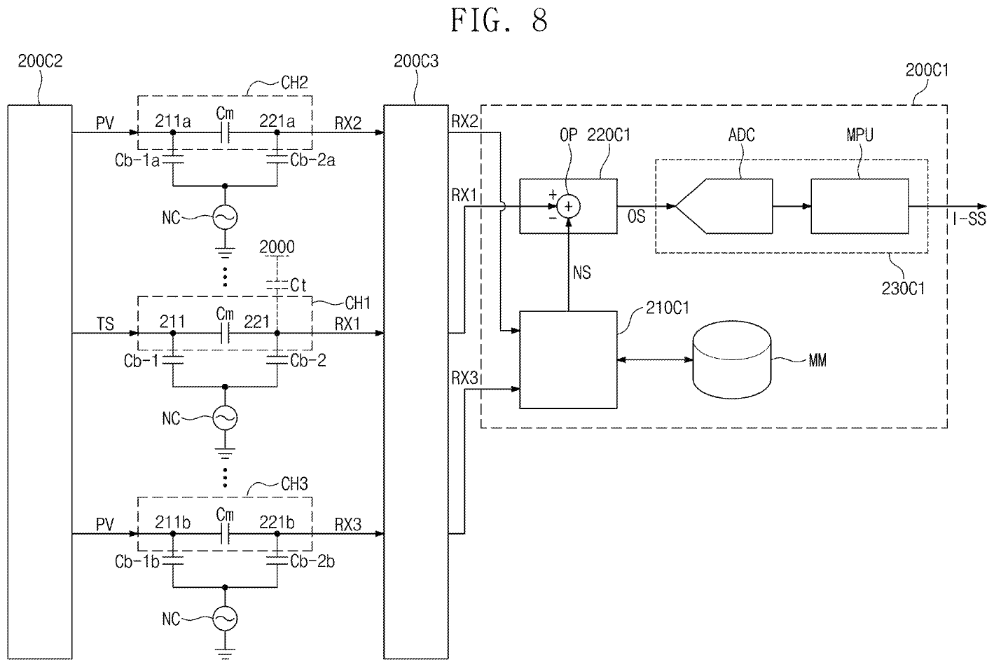

The at least two reference signals may be signals received from two or more second electrodes other than the one second electrode among the plurality of second electrodes 220. The at least two reference signals may be signals for estimating a noise signal NS (see FIG. 8) included in the first sensing signal RX1. The at least two reference signals may include a first reference signal RX2 and a second reference signal RX3.

The first reference signal RX2 may be a signal received from at least another first reference electrode among the plurality of second electrodes 220.

The second reference signal RX3 may be a signal received from at least another second reference electrode among the plurality of second electrodes 220. However, this is an example. For example, a method of receiving the first reference signal RX2 and the second reference signal RX3 according to an embodiment of the present disclosure is not limited thereto. For example, the first reference signal RX2 and the second reference signal RX3 may be signals received from dummy electrodes adjacent to the plurality of sensing electrodes SE.

The sensor control circuit 200C1 may convert an analog signal received from the input detection circuit 200C3 into a digital signal. For example, the sensor control circuit 200C1 may reduce or remove noise of the received sensing signals SS having an analog format, may amplify and filter the signal, in which the noise is reduce or removed, and may convert the filtered signal into a digital signal. This will be described later.

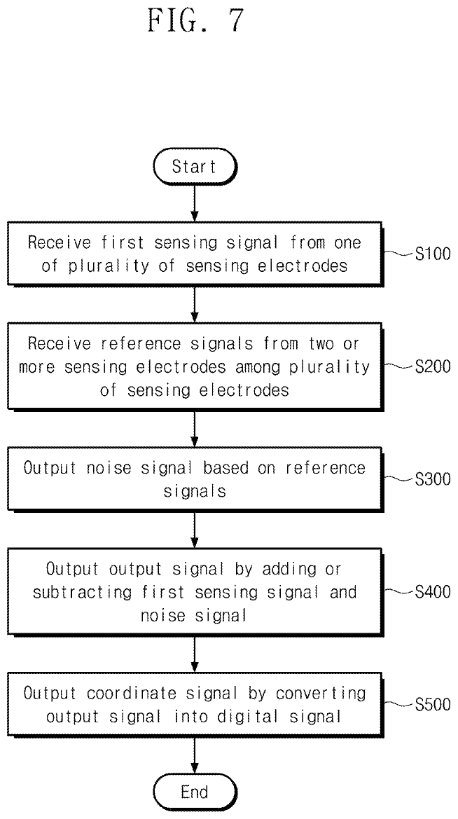

FIG. 7 is a flowchart illustrating a method of driving an electronic device, according to an embodiment of the present disclosure. FIG. 8 is a circuit diagram illustrating a sensor layer and a sensor driver, according to an embodiment of the present disclosure.

Referring to FIGS. 7 and 8, a noise source NC may be noise applied to the sensor layer 200 by a display signal provided from the scan driving circuit 100C2 (see FIG. 5), the emission driving circuit 100C3 (see FIG. 5), and/or the data driving circuit 100C4 (see FIG. 5) to the display layer 100 (see FIG. 5). For example, the noise source NC may include noise, low-frequency noise, process deviation, offset, and the like of the display layer 100 (see FIG. 5).

The amount of noise applied from the noise source NC to the sensor layer 200 may be different for each position of the sensor layer 200 depending on the display signal.

The parasitic capacitor Cb (see FIG. 4) may include first parasitic capacitors Cb-1a, Cb-1b, and Cb-1 and second parasitic capacitors Cb-2a, Cb-2b, and Cb-2.

The input detection circuit 200C3 may receive the first sensing signal RX1 from one of the plurality of sensing electrodes SE (see FIG. 6) (S100).

The signal generation circuit 200C2 may output the transfer signal TS to the sensing pattern 211 of one 1-1st electrode among the plurality of first electrodes 210 (see FIG. 6).

The first parasitic capacitor Cb-1 may be formed between the sensing pattern 211 and the noise source NC.

The second parasitic capacitor Cb-2 may be formed between the first portion 221 of one 2-1st electrode among the plurality of second electrodes 220 (see FIG. 6) and the noise source NC.

The 2-1st electrode may form a first channel CH1 together with the 1-1st electrode.

In response to the external input 2000, a change may occur in capacitance of a mutual capacitor Cm formed between the sensing pattern 211 and the first portion 221 at a corresponding point.

A sensing capacitor Ct may be formed between the external input 2000 and the sensing electrodes SE (see FIG. 6). The sensing capacitor Ct may include a first sensing capacitor formed between the external input 2000 and the sensing pattern 211 and a second sensing capacitor formed between the external input 2000 and the first portion 221.

The input detection circuit 200C3 may receive the first sensing signal RX1 from the first portion 221 (S100).

When the external input 2000 is approaching, the first sensing signal RX1 may include a first component (or first part) caused by the capacitance of the sensing capacitor Ct.

Moreover, the first sensing signal RX1 may include a second component (or second part) caused by the noise source NC.

The first sensing signal RX1 may be provided in a form of a charge-domain signal, which is an analog signal.

The sensor control circuit 200C1 may calculate the coordinate signal I-SS of the external input 2000 based on the first sensing signal RX1.

The input detection circuit 200C3 may receive the reference signals RX2 and RX3 from two or more sensing electrodes among the plurality of sensing electrodes SE (see FIG. 6) (S200).

The signal generation circuit 200C2 may output a reference signal PV to a sensing pattern 211a of one 1-2nd electrode among the plurality of first electrodes 210 (see FIG. 6). The reference signal PV may be a predetermined specific voltage.

The first parasitic capacitor Cb-1a may be formed between the sensing pattern 211a and the noise source NC.

The second parasitic capacitor Cb-2a may be formed between a first portion 221a of at least one first reference electrode among the plurality of second electrodes 220 (see FIG. 6) and the noise source NC.

The at least one first reference electrode may form a second channel CH2 together with the at least one 1-2nd electrode.

The at least one first reference electrode may be different from the 2-1st electrode. In other words, when the 2-1st electrode is one electrode of the plurality of second electrodes 220 (see FIG. 6), the at least one first reference electrode may be at least one electrode other than the one electrode among the plurality of second electrodes 220 (see FIG. 6).

A mutual capacitor Cm may be formed between the sensing pattern 211a and the first portion 221a.

The input detection circuit 200C3 may receive the first reference signal RX2 from the first portion 221a (S200). In other words, the first reference signal RX2 may be a signal received from at least one first reference electrode other than the second electrode outputting the first sensing signal RX1 among the plurality of second electrodes 220 (see FIG. 6). The first reference signal RX2 may be referred to as a “second sensing signal” RX2.

The first reference signal RX2 may include a component (or part) caused by the noise source NC.

The first reference signal RX2 may be provided in a form of a charge-domain signal, which is an analog signal.

The signal generation circuit 200C2 may output the reference signal PV to a sensing pattern 211b of at least one 1-3rd electrode among the plurality of first electrodes 210 (see FIG. 6).

The first parasitic capacitor Cb-1b may be formed between the sensing pattern 211b and the noise source NC.

The second parasitic capacitor Cb-2b may be formed between a first portion 221b of at least one second reference electrode among the plurality of second electrodes 220 (see FIG. 6) and the noise source NC.

The at least one second reference electrode may form a third channel CH3 together with the at least one 1-3rd electrode.

The at least one second reference electrode may be different from the 2-1st electrode and the at least one first reference electrode. In other words, when the 2-1st electrode is one electrode of the plurality of second electrodes 220 (see FIG. 6), the at least one first reference electrode may be at least one electrode other than the one electrode among the plurality of second electrodes 220 (see FIG. 6), and the at least one second reference electrode may be at least another electrode other than the one electrode and the at least other electrode among the plurality of second electrodes 220 (see FIG. 6).

The mutual capacitor Cm may be formed between the sensing pattern 211b and the first portion 221b.

The input detection circuit 200C3 may receive the second reference signal RX3 from the first portion 221b (S200). In other words, the second reference signal RX3 may be a signal received from at least another second reference electrode other than the second electrode, which outputs the first sensing signal RX1, and the first reference electrode among the plurality of second electrodes 220 (see FIG. 6). The second reference signal RX3 may be referred to as a third sensing signal RX3.

The second reference signal RX3 may include a component (or part) caused by the noise source NC.

The second reference signal RX3 may be provided in a form of a charge-domain signal, which is an analog signal.

The input detection circuit 200C3 may provide the sensor control circuit 200C1 with the first sensing signal RX1, the first reference signal RX2, and the second reference signal RX3.

The sensor control circuit 200C1 may include a non-ideal element estimator 210C1, a calculator 220C1, and a converter 230C1.

The non-ideal element estimator 210C1 may be connected to the input detection circuit 200C3. The non-ideal element estimator 210C1 may be implemented in hardware as a circuit.

The non-ideal element estimator 210C1 may receive the first reference signal RX2 and the second reference signal RX3 from the input detection circuit 200C3.

The non-ideal element estimator 210C1 may output the noise signal NS based on the first reference signal RX2 and the second reference signal RX3 (S300). The non-ideal element estimator 210C1 may simultaneously receive the first reference signal RX2 and the second reference signal RX3.

The noise signal NS may be a value obtained by estimating the second component of the first sensing signal RX1 and may be substantially equal to the second component. In other words, noise signal NS may correspond the impact of the noise source NC on the first sensing signal RX1.

The non-ideal element estimator 210C1 may estimate the noise signal NS in real time.

The sensor control circuit 200C1 may further include a cache memory MM. The noise signal NS output from the non-ideal element estimator 210C1 may be stored in the cache memory MM. The stored noise signal NS may be used when noise of a channel different from the first channel CH1 is extracted.

The calculator 220C1 may be connected to the input detection circuit 200C3 and the non-ideal element estimator 210C1.

The calculator 220C1 may receive the first sensing signal RX1 from the input detection circuit 200C3 and the noise signal NS from the non-ideal element estimator 210C1.

The calculator 220C1 may output an output signal OS by adding or subtracting the first sensing signal RX1 and the noise signal NS (S400).

The calculator 220C1 may include an operator OP. The operator OP may output a value obtained by adding the first sensing signal RX1 and subtracting the noise signal NS. The value may be output as the output signal OS. In other words, the operator OP may perform the function of an adder circuit that is a type of digital circuit that performs addition of numbers, and a subtractor circuit that is a type of digital circuit used for subtracting one number from another.

The output signal OS may be provided as a charge-domain signal, which is an analog signal.

The converter 230C1 may be connected to the calculator 220C1. The converter 230C1 may receive the output signal OS from the calculator 220C1. The converter 230C1 may output the coordinate signal I-SS by converting the output signal OS into a digital signal (S500).

The converter 230C1 may include an analog-to-digital converter ADC and a signal processing unit MPU.

The analog-to-digital converter ADC may convert the output signal OS, which is an analog signal, into a digital signal.

The signal processing unit MPU may perform signal processing on the output signal OS to be converted into a digital signal, and may detect the external input 2000 depending on the signal processing result. The signal processing unit MPU may output the coordinate signal I-SS. The signal processing unit MPU may be implemented as a microprocessor (MPU) or a microcontroller (MCU).

The coordinate signal I-SS may be provided as a voltage-domain signal that is a digital signal.

Unlike an embodiment of the present disclosure, when an operation of removing noise in a digital signal area such as a voltage-domain signal is performed, noise is also converted in converting an analog signal to a digital signal, and thus, a signal may be lost due to distortion due to signal saturation. In other words, since the analog-to-digital conversion also converts the noise, there is a risk of losing signal information due to distortion. However, according to an embodiment of the present disclosure, when the first sensing signal RX1 is an analog signal before being converted into a digital signal, the calculator 220C1 may add or subtract the first sensing signal RX1 and the noise signal NS. In other words, the calculator 220C1 is employed to remove the noise signal NS to produce an output signal OS devoid of the negative effects of noise. In the calculator 220C1, the noise-removed output signal OS may be output. The converter 230C1 may convert the output signal OS into a digital signal in a state where noise is removed. In other words, in converting an analog signal to a digital signal, signal loss due to signal saturation caused when noise is converted together may be prevented. Accordingly, the electronic device 1000 (see FIG. 1) having improved sensing reliability may be provided.

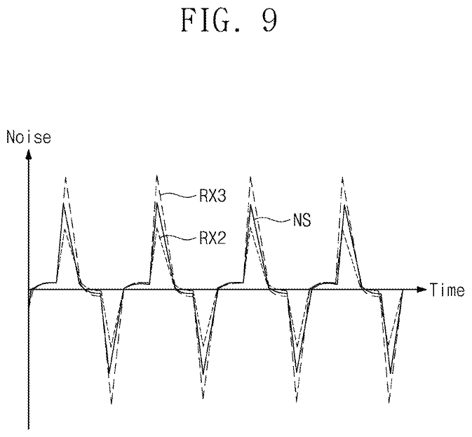

FIG. 9 is a graph showing sensing signals and reference signals, according to an embodiment of the present disclosure.

In FIG. 9, a horizontal axis may indicate a time, and a vertical axis may indicate the intensity of a noise signal.

Referring to FIGS. 6, 8, and 9, the non-ideal element estimator 210C1 may estimate the noise signal NS based on the first reference signal RX2 and the second reference signal RX3.

The magnitude of the noise signal NS may be changed depending on a position of a channel formed by the plurality of sensing electrodes SE. When viewed from above a plane, the noise signal NS measured at each of the plurality of second electrodes 220 may gradually change in the second direction DR2. For example, the noise signal NS may gradually increase or decrease in the second direction DR2 in which the plurality of second electrodes 220 are arranged.

The non-ideal element estimator 210C1 may calculate the noise signal NS by adding or subtracting values obtained by respectively multiplying the first reference signal RX2 and the second reference signal RX3 by predetermined ratios. For example, the noise signal NS may be obtained by adding a first value from multiplying the first reference signal RX2 by a predetermined first ratio and a second value from multiplying the second reference signal RX3 by a predetermined second ratio. In other words, the noise signal NS may be obtained by adding two components, the first is obtained by multiplying the first reference signal RX2 by a predetermined first ratio, and the second is obtained by multiplying the second reference signal RX3 by a predetermined second ratio.

Each of the first ratio and the second ratio may be a rational number.

Unlike an embodiment of the present disclosure, in a driving method for removing common-mode noise, the noise signal may be removed assuming that noise signals applied to the sensor layer 200 are the same as each other. In this case, if there is a non-common-mode noise signal component, the magnitude of which varies based on the position of a channel formed by the plurality of sensing electrodes SE, the effectiveness of noise signal removal may be degraded. However, according to an embodiment of the present disclosure, the non-ideal element estimator 210C1 may accurately estimate the noise signal NS from the first reference signal RX2 and the second reference signal RX3. The calculator 220C1 may output the output signal OS, from which noise components are removed, by adding or subtracting the noise signal NS, which is estimated based on the first sensing signal RX1 and the noise signal NS, to or from the first sensing signal RX1. Thus, the non-common-mode noise signal component whose magnitude is changed depending on the position of a channel formed by the plurality of sensing electrodes SE may be easily reduced or removed. Sensitivity may be improved by increasing the signal to noise ratio (SNR) of the sensor layer 200 (see FIG. 6). In other words, the reliability and accuracy of a touch signal obtained by the electronic device 1000 (see FIG. 1) may be improved. Accordingly, the electronic device 1000 (see FIG. 1) having improved sensing reliability may be provided.

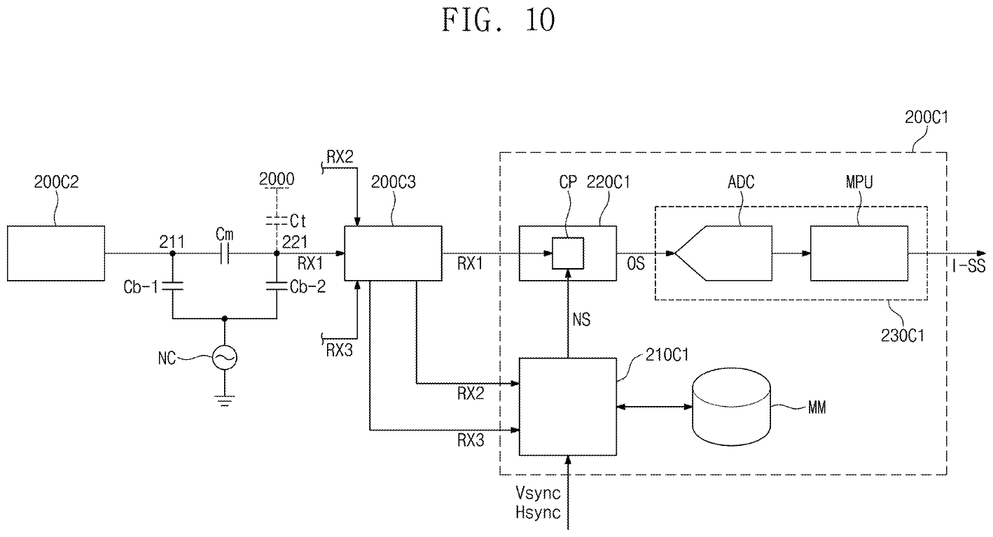

FIG. 10 is a circuit diagram illustrating a sensor layer and a sensor driver, according to an embodiment of the present disclosure. In the description of FIG. 10, the same reference numerals are assigned to the same components described with reference to FIG. 8, and thus the descriptions thereof are omitted to avoid redundancy.

Referring to FIG. 10, the calculator 220C1 may include a charge pump CP. However, this is an example. For example, the calculator 220C1 according to an embodiment of the present disclosure is not limited thereto and may be provided in various ways as long as it has a configuration capable of adding or subtracting the received signal.

The charge pump CP may step up or step down voltage levels of the received signals. For example, the charge pump CP may reduce a voltage level of the first sensing signal RX1 by the voltage level of the noise signal NS.

The charge pump CP may output the output signal OS based on the first sensing signal RX1 and the noise signal NS.

The sensor control circuit 200C1 may receive the vertical synchronization signal Vsync and/or the vertical synchronization signal Hsync that are generated by the display driver 100C (see FIG. 5).

The vertical synchronization signal Vsync and/or the vertical synchronization signal Hsync may be provided to the non-ideal element estimator 210C1.

The non-ideal element estimator 210C1 may output the noise signal NS by further using the vertical synchronization signal Vsync and/or the vertical synchronization signal Hsync. In this case, the non-ideal element estimator 210C1 may process a digital signal as well as an analog signal. The non-ideal element estimator 210C1 may determine when noise of the display layer 100 (see FIG. 5) is applied to the sensor layer 200 (see FIG. 6), based on the vertical synchronization signal Vsync and/or the vertical synchronization signal Hsync.

According to an embodiment of the present disclosure, the non-ideal element estimator 210C1 may determine timing at which the noise of the display layer 100 (see FIG. 5) is provided. In other words, the non-ideal element estimator 210C1 can determine the timing at which the display layer's 100 noise is generated. The non-ideal element estimator 210C1 may receive the first reference signal RX2 and the second reference signal RX3, which include a noise element, based on the timing. The non-ideal element estimator 210C1 may accurately calculate the noise signal NS by adding or subtracting values obtained by respectively multiplying the first reference signal RX2 and the second reference signal RX3 by predetermined ratios. The calculator 220C1 may output the output signal OS, from which a noise element is removed. Sensitivity may be improved by increasing the SNR of the sensor layer 200 (see FIG. 6). In other words, the reliability and accuracy of a touch signal obtained by the electronic device 1000 (see FIG. 1) may be improved. Accordingly, the electronic device 1000 (see FIG. 1) having improved sensing reliability may be provided.

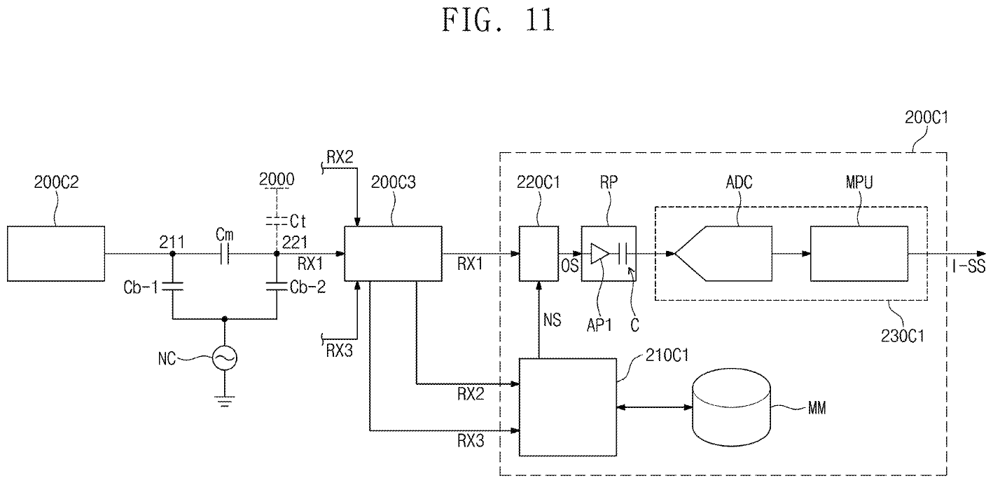

FIG. 11 is a circuit diagram illustrating a sensor layer and a sensor driver, according to an embodiment of the present disclosure. In the description of FIG. 11, the same reference numerals are assigned to the same components described with reference to FIG. 8, and thus the descriptions thereof are omitted to avoid redundancy.

Referring to FIG. 11, the sensor control circuit 200C1 may further include a repeater RP. The repeater RP may be connected between the calculator 220C1 and the converter 230C1.

The repeater RP may simply amplify the analog signal and may transmit the analog signal to the next stage. The repeater RP may improve the dynamic range of the output signal OS.

The repeater RP may include a first operational amplifier AP1 and a capacitor ‘C’. The first operational amplifier AP1 and the capacitor ‘C’ may be serially connected to each other.

The first operational amplifier AP1 may include an operational amplifier (OP amp). The first operational amplifier AP1 may be connected with the calculator 220C1. The first operational amplifier AP1 may have a single-input single-output (SISO) structure. An input terminal of the first operational amplifier AP1 may receive the output signal OS from the calculator 220C1. An output terminal of the first operational amplifier AP1 may be connected to the capacitor ‘C’.

The capacitor ‘C’ may be connected between the first operational amplifier AP and an analog-to-digital converter ADC.

According to an embodiment of the present disclosure, the calculator 220C1 may output the noise-removed output signal OS by adding or subtracting the first sensing signal RX1 and the noise signal NS. The repeater RP may amplify the output signal OS, from which noise is removed, and may transmit the amplified signal to the analog-to-digital converter ADC. The converter 230C1 may output the coordinate signal I-SS, from which noise is reduced or removed based on the output signal OS. Sensitivity may be improved by increasing the SNR of the sensor layer 200 (see FIG. 6). In other words, the reliability and accuracy of a touch signal obtained by the electronic device 1000 (see FIG. 1) may be improved. Accordingly, the electronic device 1000 (see FIG. 1) having improved sensing reliability may be provided.

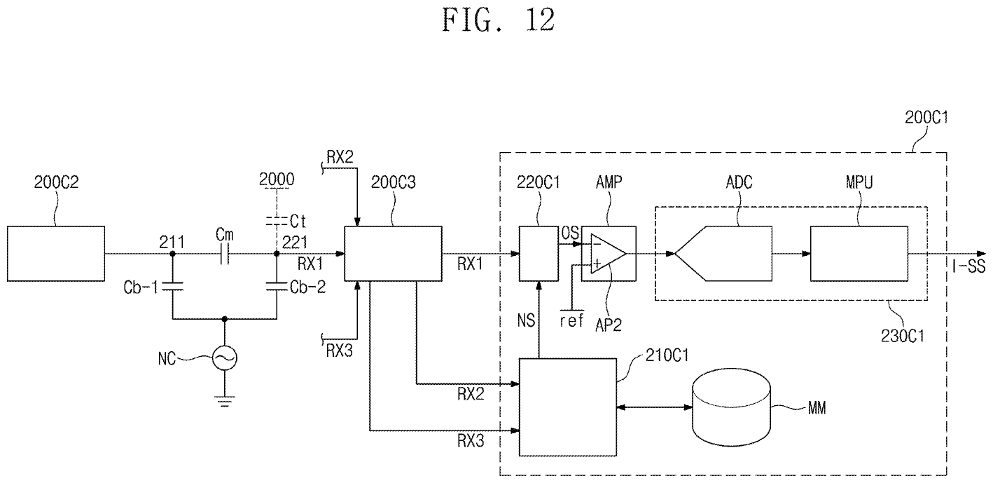

FIG. 12 is a circuit diagram illustrating a sensor layer and a sensor driver, according to an embodiment of the present disclosure. In the description of FIG. 12, the same reference numerals are assigned to the same components described with reference to FIG. 8, and thus the descriptions thereof are omitted to avoid redundancy.

Referring to FIG. 12, the sensor control circuit 200C1 may further include an amplifier AMP. The amplifier AMP may be connected between the calculator 220C1 and the converter 230C1.

The amplifier AMP may amplify an analog signal and may transmit the analog signal to the next stage. The amplifier AMP may improve the dynamic range of the output signal OS.

The amplifier AMP may include a second operational amplifier AP2.

The second operational amplifier AP2 may include an operational amplifier (OP amp). A first input terminal of the second operational amplifier AP2 may be connected to the calculator 220C1. A second input terminal of the second operational amplifier AP2 may receive a reference signal ref that operates at a specific interval. The first input terminal may be referred to as a “negative input node”, and the second input terminal may be referred to as a “positive input node”. An output terminal of the second operational amplifier AP2 may be connected to the analog-to-digital converter ADC.

The second operational amplifier AP2 may have a single-ended structure and may have an open loop structure. However, this is an example. For example, the structure of the second operational amplifier AP2 according to an embodiment of the present disclosure is not limited thereto.

According to an embodiment of the present disclosure, the calculator 220C1 may output the noise-removed output signal OS by adding or subtracting the first sensing signal RX1 and the noise signal NS. The repeater RP may amplify the output signal OS, from which noise is removed, and may transmit the amplified signal to the analog-to-digital converter ADC. The converter 230C1 may output the coordinate signal I-SS, from which noise is reduced or removed based on the output signal OS. Sensitivity may be improved by increasing the SNR of the sensor layer 200 (see FIG. 6). In other words, the reliability and accuracy of a touch signal obtained by the electronic device 1000 (see FIG. 1) may be improved. Accordingly, the electronic device 1000 (see FIG. 1) having improved sensing reliability may be provided.

As described above, a non-ideal element estimator may accurately estimate a noise signal from at least two reference signals. A calculator may output an output signal obtained by reducing or removing noise components from a first sensing signal. Sensitivity may be improved by increasing a the SNR of a sensor layer. In other words, the reliability and accuracy of a touch signal obtained by an electronic device may be improved. Accordingly, it is possible to provide the electronic device with improved sensing reliability.

While the present disclosure has been described with reference to embodiments thereof, it will be apparent to those of ordinary skill in the art that various changes and modifications may be made thereto without departing from the spirit and scope of the present disclosure as set forth in the following claims.

What is claimed is:

1. An electronic device comprising:
a display layer;
a sensor layer disposed on the display layer and including a plurality of first electrodes and a plurality of second electrodes crossing the plurality of first electrodes; and
a sensor driver configured to drive the sensor layer and including a signal generation circuit configured to transmit a transfer signal to the plurality of first electrodes, an input detection circuit configured to receive a sensing signal from the plurality of second electrodes, and a sensor control circuit,
wherein the input detection circuit is configured to:
receive a first sensing signal from one electrode among the plurality of second electrodes, a second sensing signal from a first reference electrode among the plurality of second electrodes, and a third sensing signal from a second reference electrode among the plurality of second electrodes, wherein the one electrode, the first reference electrode and the second electrode are different from each other, and
wherein the sensor control circuit includes:
a non-ideal element estimator configured to output a noise signal based on the second sensing signal and the third sensing signal;
a calculator configured to output an output signal by adding or subtracting the first sensing signal and the noise signal; and
a converter configured to output a coordinate signal by converting the output signal into a digital signal.

2. The electronic device of claim 1, wherein each of the first sensing signal, the second sensing signal, the third sensing signal, the noise signal, and the output signal is a charge-domain signal that is an analog signal, and
wherein the coordinate signal is a voltage-domain signal that is a digital signal.

3. The electronic device of claim 1, wherein the calculator includes a charge pump.

4. The electronic device of claim 1, wherein the non-ideal element estimator simultaneously receives the second sensing signal and the third sensing signal.

5. The electronic device of claim 1, wherein the sensor control circuit further includes a cache memory, and
wherein the cache memory stores the noise signal.

6. The electronic device of claim 1, wherein the non-ideal element estimator is connected to the calculator, and
wherein the calculator is connected to the input detection circuit, the non-ideal element estimator, and the converter.

7. The electronic device of claim 1, wherein the sensor control circuit further includes a repeater connected between the calculator and the converter.

8. The electronic device of claim 7, wherein the repeater includes an operational amplifier and a capacitor, which are connected in series with each other.

9. The electronic device of claim 1, wherein the sensor control circuit further includes a charge amplifier connected between the calculator and the converter.

10. The electronic device of claim 9, wherein the charge amplifier has a single-ended structure.

11. The electronic device of claim 9, wherein the charge amplifier has an open loop structure.

12. The electronic device of claim 1, further comprising:
a display driver configured to drive the display layer,
wherein the display driver generates a vertical synchronization signal and a horizontal synchronization signal,
wherein the sensor control circuit receives the vertical synchronization signal and the horizontal synchronization signal, and
wherein the non-ideal element estimator outputs the noise signal by further using the vertical synchronization signal and the horizontal synchronization signal.

13. The electronic device of claim 1, wherein the non-ideal element estimator calculates the noise signal by adding or subtracting values obtained by multiplying the second sensing signal by a predetermined first ratio and the third sensing signal by a predetermined second ratio.

14. The electronic device of claim 1, wherein, when the sensor driver detects the second sensing signal and the third sensing signal, the signal generation circuit provides a voltage to the plurality of first electrodes.

15. An electronic device comprising:
a display layer;
a sensor layer disposed on the display layer and including a plurality of sensing electrodes; and
a sensor driver including:
a signal generation circuit configured to drive the sensor layer and to transmit a first transfer signal to a first electrode among the plurality of sensing electrodes;
an input detection circuit configured to receive a first sensing signal from a second electrode among the plurality of sensing electrodes, and first and second reference signals from at least two sensing electrodes other than the first electrode and the second electrode among the plurality of sensing electrodes; and
a sensor control circuit, and
wherein the sensor control circuit includes:
a non-ideal element estimator configured to output a noise signal based on the first and second reference signals;
a calculator configured to output an output signal by adding or subtracting the first sensing signal and the noise signal; and
a converter configured to output a coordinate signal by converting the output signal into a digital signal.

16. The electronic device of claim 15, wherein the calculator includes a charge pump.

17. The electronic device of claim 15, wherein the sensor control circuit further includes a cache memory, and
wherein the cache memory stores the noise signal.

18. The electronic device of claim 15, wherein the non-ideal element estimator is connected to the calculator, and
wherein the calculator is connected to the input detection circuit, the non-ideal element estimator, and the converter.

19. The electronic device of claim 15, wherein the sensor control circuit further includes an amplifier connected between the calculator and the converter.

20. The electronic device of claim 15, further comprising:
a display driver configured to drive the display layer,
wherein the display driver generates a vertical synchronization signal and a horizontal synchronization signal,
wherein the sensor control circuit receives the vertical synchronization signal and the horizontal synchronization signal, and
wherein the non-ideal element estimator outputs the noise signal by further using the vertical synchronization signal and the horizontal synchronization signal.
